(19) United States
(12) Patent Application Publication
(10) Pub. No.: US 2016/0192629 A1
(43) Pub. Date: Jul. 7, 2016

(54) POLYURETHANE FOAM HANDLE AND METHOD FOR MAKING THE SAME

(71) Applicant: Bo-Hyun CHOI, Busan (KR)

(72) Inventor: Bo-Hyun CHOI, Busan (KR)

(21) Appl. No.: 14/594,330

(22) Filed: Jan. 12, 2015

(30) Foreign Application Priority Data
Jan. 2, 2015 (KR) 10-2015-0000216

(51) Int. Cl. A01K 87/08; B29C 65/00; B29C 37/00; B29C 65/48; B29C 44/02; B29C 44/34

(52) U.S. Cl. CPC A01K 87/08; B29C 44/02; B29C 44/34; B29C 37/0025; B29C 65/48; B29C 66/7481; B29L 2031/7002

(57) ABSTRACT

A polyurethane foam handle includes: a polyurethane foam having the shape and size of the handle; a coating layer formed on the surface of the polyurethane foam; and an additive disposed inside the coating layer, in which the additive is cork powder, white clay, yellow soil, a coloring matter, shellfish powder, metal powder, shiny powder, or a compound of them. The foam handle solves the problems due to using EVA or cork to make a handle and to achieve a polyurethane foam handle over the defects of polyurethane foam.

### CROSS-REFERENCE TO RELATED APPLICATIONS

This application claims the priority of Korean Patent Application No. 10-2015-0000216 filed on Jan. 2, 2015, in the Korean Intellectual Property Office, the disclosure of which is incorporated herein by reference.

### BACKGROUND OF THE INVENTION

1. Field of the Invention

The present invention relates to a polyurethane foam handle.

2. Description of the Related Art

The handles of fishing rods and alpenstocks are usually made of EVA (Ethylene-Vinyl Acetate) or cork. The handle of a fishing rod is exemplified in the following description.

EVA is a material that is inexpensive and has various colors. However, a handle made of EVA has poor strength of stability and high specific gravity, so it is too heavy and easily slides a hand with water.

Cork, a tissue inside the bark of an oak, is a material that does not pass liquid or air and has elasticity. However, since cork is a natural material, the quality of a handle made of cork depends on the quality of the cork. Further, cork, a natural material, has cracks and is expensive when there are fewer cracks, so it increases the making cost of a handle. Further, cork is easily broken, so it is difficult to make a handle with various shapes and sizes by shaving cork and a handle made of cork is easily broken in use.

### SUMMARY OF THE INVENTION

An aspect of the present invention provides a polyurethane foam handle without the problems due to using EVA or cork to make a handle, and a method for making the polyurethane foam handle.

According to an aspect of the present invention, there is provided a polyurethane foam handle including: a polyurethane foam having the shape and size of the handle; a coating layer formed on the polyurethane foam; and an additive disposed inside the coating layer, in which the additive is cork powder, white clay, yellow soil, a coloring matter, shellfish powder, metal powder, shiny powder, or a compound of them.

The polyurethane foam handle may include: a polyurethane foam having the shape and size of the handle; a coating layer formed on the surface of the polyurethane foam with a thickness of 0.05 to 0.5 mm; an additive added in the coating layer; and a cap finishing an end of the polyurethane foam, in which the additive may be cork powder, white clay, yellow soil, a coloring matter, shellfish powder, metal powder, shiny powder, or a compound of them and the cap is made of EVA, cork, or rubber.

According to another aspect of the present invention, there is provided a method for making a polyurethane foam handle which includes: forming a polyurethane foam having the shape and size of the handle from a lump of polyurethane foam; adding an additive, which is cork powder, white clay, yellow soil, a coloring matter, shellfish powder, metal powder, shiny powder, or a compound of them, to paint; and forming a coating layer by applying the paint with the additive to the surface of the polyurethane foam.

The method may include: forming a polyurethane foam having the shape and size of the handle from a lump of polyurethane foam; adding an additive, which is cork powder, white clay, yellow soil, a coloring matter, shellfish powder, metal powder, shiny powder, or a compound of them, to paint; forming a coating layer having a thickness of 0.05 to 0.5 mm by applying the paint with the additive to the surface of the polyurethane foam; and bonding a cap made of EVA, cork, or rubber to an end of the polyurethane foam.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating a handle according to an embodiment of the present invention mounted on the grip of a fishing rod;

FIG. 2 is a cross-sectional view taken along line II-II of FIG. 1;

FIG. 3 is a view illustrating the polyurethane foam of FIG. 1 equipped with a cap at the end; and

FIG. 4 is a flowchart illustrating a method for making a handle according to an embodiment of the present invention.

### DETAILED DESCRIPTION OF THE PREFERRED EMBODIMENT

Exemplary embodiments of the present invention will now be described in detail with reference to the accompanying drawings.

Hereinafter, a handle according to an embodiment of the present invention will be described in detail.

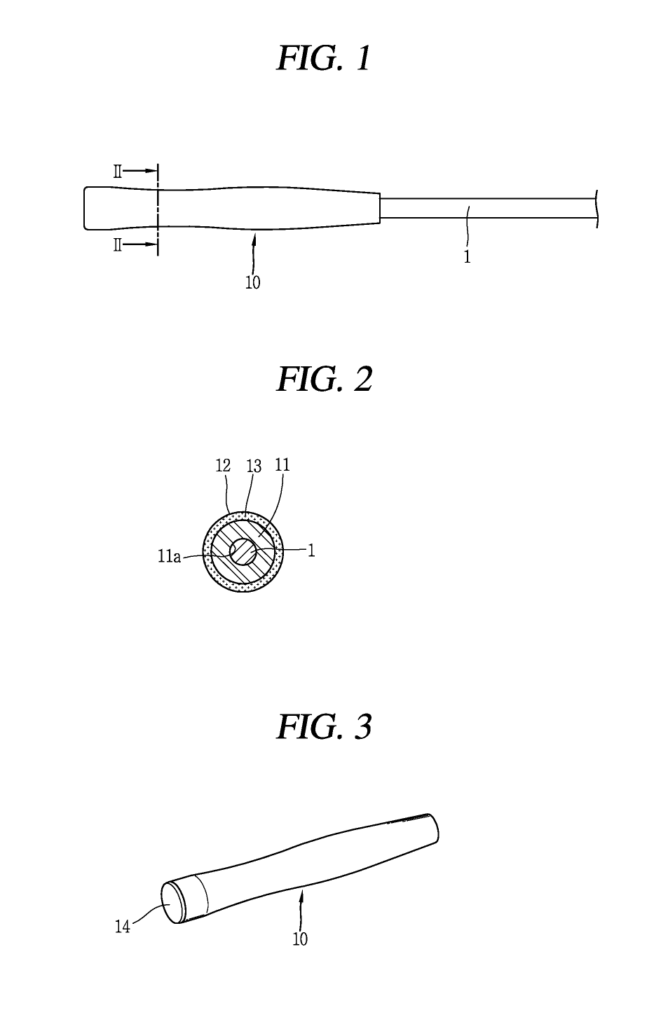

FIG. 1 is a view illustrating a handle according to an embodiment of the present invention mounted on the grip of a fishing rod. As illustrated in FIG. 1, a handle 10 is fitted or bonded on an end portion of a fishing rod 1. Obviously, the handle 10 may be disposed at the middle portion, the end portion, or other portions than the middle portion of the fishing rod 1. Further, the handle 10 may be disposed at several portions of the fishing rod 1. The portion with the handle 10 is called a grip.

Although the handle 10 is mounted at the grip of a fishing rod in the embodiment, it may be mounted at the grip of an alpenstock.

FIG. 2 is a cross-sectional view taken along line II-II of FIG. 1.

As illustrated in FIG. 2, the handle 10 is composed of a polyurethane foam 11, a coating layer 12, and an additive 13.

The polyurethane foam 11 has the shape and size of the handle. That is, the polyurethane foam 11 substantially decides the shape and size of the handle 10.

A hole 11a for inserting the fishing rod 1 is formed through the center of the polyurethane foam 11.

The size of the hole 11a maybe the same as the diameter of the fishing rod 1 so that the fishing rod 1 can be fitted therein.

Alternatively, the size of the hole 11a maybe a little larger than the diameter of the fishing rod 1 in order to put an adhesive on the fishing rod 1 and then insert it into the hole 11a.

The coating layer 12 is formed thin on the polyurethane foam 11.

The coating layer 12 is 0.05 to 0.5 mm thick.

When the coating layer 12 is thinner than 0.05 mm, it is difficult to prevent fine powder from coming off from the polyurethane foam 11.

In contrast, when the coating layer 12 is thicker than 0.5 mm, a user has difficulty in feeling the material and hardness of the polyurethane foam 11.

The thickness of 0.05 to 0.5 mm of the coating layer 12 is a critical value obtained through repeated tests by the applicant.

The additive 13 is disposed inside the coating layer 12. Environment-friendly materials (cork powder, white clay, and yellow soil) or compounds of them may be used for the additive 13. Using an environment-friendly material for the additive 13 is good for health and improves the feel of the handle 10.

Further, when an environment-friendly material is used for the additive 13, the surface shape of the handle 10 randomly changes, so it is possible to naturally obtain various shapes of handles 10.

Alternatively, coloring matters, shellfish powder, metal powder, shiny powder, or compounds of them may be used for the additive 13. Accordingly, it is possible to give various colors and beautiful decoration to the handle 10.

FIG. 3 is a view illustrating the polyurethane foam of FIG. 1 equipped with a cap at the end.

As illustrated in FIG. 3, a cap 14 may be bonded to an end of the polyurethane foam 11. Although the cap 14 is bonded only to the left end of the polyurethane foam 11 in the embodiment, it maybe possible to bond the cap 14 to both the left and right ends of the polyurethane foam 11.

The cap 14 is made of EVA, cork, or rubber. The cap 14 may be thick or thin.

It is possible to finish the end of the polyurethane foam 11 by bonding the cap 14 to the end.

As the cap 14 is bonded to the end of the polyurethane foam 11, it is possible to prevent water from flowing inside between the polyurethane foam 11 and the fishing rod 1.

Further, it is possible to vary the handle 10 by finishing the end of the polyurethane foam 11 with other materials.

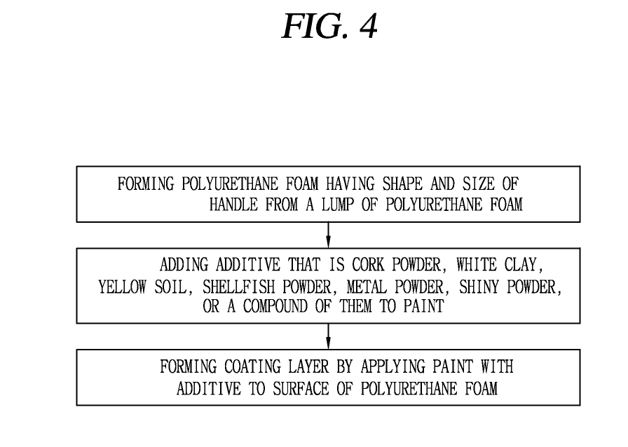

FIG. 4 is a flowchart illustrating a method for making a handle according to an embodiment of the present invention.

As illustrated in FIG. 4, a method for making a handle according to an embodiment of the present invention includes: making a polyurethane foam having the shape and size of a desired handle from a lump of polyurethane foam (S11); adding an additive, which is cork powder, white clay, yellow soil, shellfish powder, metal powder, shiny powder, or a compound of them to paint (S12); and forming a coating layer by applying the paint with the additive to the surface of the polyurethane foam (S13).

The step (S11) is described hereafter.

Referring to FIGS. 1 and 2, the polyurethane foam 11 having the shape and size of the handle 10 is formed by cutting and shaving a lump of polyurethane foam. In the process of forming the polyurethane foam 11, it may be possible to make the feel of material of the handle 10 different by adjusting the roughness of the surface of the polyurethane foam 11.

The step (S12) is described hereafter.

Referring to FIGS. 1 and 2, the additive 13 is mixed with paint. The paint may be transparent clay or color paint.

The additive 13 may be cork powder, white clay, yellow soil, a coloring matter, shellfish powder, metal powder, shiny powder, or a compound of them. When the paint is color paint, there is no need for putting a coloring matter into the additive 13.

The step (S13) is described hereafter.

Referring to FIGS. 1 and 2, paint with an additive is put on the surface of the polyurethane foam 11 by a brush or paint with an additive is applied by a spray. Alternatively, paint with an additive is applied to the surface of the polyurethane foam 11 by repeatedly putting the polyurethane foam 11 into and out of a container with the paint.

Alternatively, paint with an additive is applied to the surface of the polyurethane foam 11 by putting the polyurethane foam 11 into a container with the paint and then rotating the polyurethane foam 11 with a machine.

While the paint with an additive is applied to the surface of the polyurethane foam 11, porosities of the polyurethane foam 11 are filled with the paint. The coating layer 12 is formed on the polyurethane foam 11 by hardening of the paint with an additive.

After the step (S13), bonding the cap 14 (see FIG. 3) to an end of the polyurethane foam may be further provided.

The reason for bonding the cap 14 (see FIG. 3) to an end of the polyurethane foam 11 was described above, so it is not described here.

As set forth above, according to exemplary embodiments of the invention, it is possible to achieve a polyurethane foam handle that is not noxious and strong against a temperature change, and has good formability, easily adjustable hardness, good strength of stability, low specific gravity, and a high friction coefficient. Therefore, it is possible to achieve a handle having the advantages of polyurethane foam, that is, it has high strength of stability and does not easily slide on water.

According to the present invention, since the grip of a fishing rod or an alpenstock is made of polyurethane foam, the fishing rod or the alpenstock become light, thereby reducing fatigue in fishing or climbing.

According to the present invention, a handle with various shapes and sizes are made by cutting and shaving a lump of polyurethane foam. Therefore, there is no need for separately making molds for various shapes and sizes of handle, thereby reducing the making cost of a handle.

Further, a polyurethane foam is easily formed, so it is possible to easily achieve a polyurethane foam fitting to the shape and size of a handle from a lump of polyurethane foam. Further, a polyurethane foam is hard, so a handle made of the polyurethane foam is not easily broken in use.

According to the present invention, the defects of polyurethane foam that water can easily permeate due to a lot of porosities, fine powders come off from the surface when a user touches it with a hand, and the color is simple (usually yellow and black) are solved as follows.

First, since paint with cork power, white clay, yellow soil, or a compound of them is applied to the surface of a polyurethane foam, it is possible to prevent water from easily permeating due to a lot of porosities and fine powders from coming off from the surface when a user touches it with a hand.

Second, it is possible to achieve various colors for a simple polyurethane foam by adding various coloring matters to paint.

Third, it is possible to achieve various and decorative surface of a polyurethane foam by mixing shellfish powder, metal powder, or shiny powder with paint.

Fourth, it is possible to achieve various feels of material by adjusting the roughness of the surface of a polyurethane foam.

As described above, according to the present invention, it is possible to solve the problems due to using EVA or cork to make a handle and to achieve a polyurethane foam handle over the defects of polyurethane foam.

While the present invention has been illustrated and described in connection with the exemplary embodiments, it will be apparent to those skilled in the art that modifications and variations can be made without departing from the spirit and scope of the invention as defined by the appended claims.

1. A polyurethane foam handle comprising:
a polyurethane foam having the shape and size of the handle;
a coating layer formed on the polyurethane foam; and
an additive disposed inside the coating layer,
wherein the additive is cork powder, white clay, yellow soil, a coloring matter, shellfish powder, metal powder, shiny powder, or a compound of them.

2. The polyurethane foam handle of claim 1, wherein the coating layer is 0.05 to 0.5 mm thick.

3. The polyurethane foam handle of claim 1, wherein a cap is disposed at an end of the polyurethane foam.

4. The polyurethane foam handle of claim 3, wherein the cap is made of EVA, cork, or rubber.

5. The polyurethane foam handle of claim 1, wherein a hole for inserting the grip of a fishing rod or an alpenstock is formed through the center of the polyurethane foam, and
the grip of a fishing rod or an alpenstock is fitted in the hole or bonded in the hole.

6. A method for making the polyurethane foam handle of claim 1, the method comprising:
forming a polyurethane foam having the shape and size of the handle from a lump of polyurethane foam;
adding an additive, which is cork powder, white clay, yellow soil, a coloring matter, shellfish powder, metal powder, shiny powder, or a compound of them, to paint; and
forming a coating layer by applying the paint with the additive to the surface of the polyurethane foam.

7. The method of claim 6, wherein the coating layer is 0.05 to 0.5 mm thick.

8. The method of claim 6, further comprising bonding a cap made of EVA, cork, or rubber to an end of the polyurethane foam.
